(19) United States
(12) Patent Application Publication
(10) Pub. No.: US 2025/0203476 A1
(43) Pub. Date: Jun. 19, 2025

(54) COMMUNICATION NODE APPARATUS, COMMUNICATION APPARATUS, AND COMMUNICATION SYSTEM

(71) Applicant: CANON KABUSHIKI KAISHA, Tokyo (JP)

(72) Inventor: MIZUHO AOYAGI, Tokyo (JP)

(21) Appl. No.: 19/069,761

(22) Filed: Mar. 4, 2025

Related U.S. Application Data
(63) Continuation of application No. PCT/JP2023/031664, filed on Aug. 31, 2023.

(30) Foreign Application Priority Data
Sep. 9, 2022 (JP) 2022-144159

(51) Int. Cl. H04W 36/08; H04W 8/26

(52) U.S. Cl. CPC H04W 36/08; H04W 8/26

(57) ABSTRACT

A communication node apparatus for providing a public network communication service includes a transmission unit for transmitting, in a case of handing over a communication apparatus existing under the communication node apparatus to a different communication node apparatus, association information for associating the communication apparatus with an own node, to the communication apparatus or the different communication node apparatus. The association information is information to be used in determining a next handover destination for the communication apparatus handed over to the different communication node apparatus, and is information that makes an effect of increasing a possibility of being selected as the next handover destination.

### CROSS-REFERENCE TO RELATED APPLICATIONS

This application is a Continuation of International Patent Application No. PCT/JP2023/031664, filed Aug. 31, 2023, which claims the benefit of Japanese Patent Application No. 2022-144159, filed Sep. 9, 2022, both of which are hereby incorporated by reference herein in their entirety.

### BACKGROUND OF THE INVENTION

### Field of the Invention

The present disclosure relates to a communication node apparatus, a communication apparatus, and a communication system.

### Background Art

In the 3rd Generation Partnership Project (3GPP)®, the standardization of an Integrated Access and Backhaul (IAB) has been progressed as a communication technique for a backhaul.

The IAB technique is a technique that uses, as backhaul communication, millimeterwave wireless communication in a 28-gigahertz (GHz) band or the like that is used for access communication between a base station and a user equipment (UE) (PTL 1).

In a backhaul communication network that uses the IAB technique (hereinafter, IAB network), a relay device called an IAB node relays (base station relay) communication from an IAB donor equivalent to a conventional base station, up to a destination UE. The IAB node has a function equivalent to a base station that accepts connection from a UE.

### CITATION LIST

### Patent Literature

PTL 1: Japanese Unexamined Patent Application Publication No. 2019-534625

### SUMMARY OF THE INVENTION

On the other hand, in a handover via a communication node apparatus such as an IAB node, it is conceivable to hand over a UE connected to a specific communication node apparatus, to a different communication node apparatus for the purpose of load distribution or the like. Here, for example, in a case where the purpose is temporary load distribution, the UE handed over to the different communication node apparatus is sometimes desired to be handed over again to the specific communication node apparatus, and managed in the specific communication node apparatus.

Nevertheless, in the above-described prior art, a use case has not been considered where a UE is preferentially handed over again to an original communication node apparatus to which the UE has been connected before the handover. This arises an issue that, in handover processing via a communication node apparatus like an IAB node, an original communication node apparatus to which the UE has been connected before the handover cannot be identified, and accordingly the UE cannot be preferentially handed over again to the original communication node apparatus. In addition, in the above-described prior art, it has been generally known to select a handover destination based on radio field intensity. Nevertheless, there is an issue that there is no structure for issuing a notification serving as information that is different from the radio field intensity and indicates a handover destination, and flexible handover processing cannot be realized.

The present invention has been devised in view of at least one of the above-described problems. An aspect of the present invention is directed to providing a structure for appropriately issuing a notification including information for preferentially handing over a UE to an original communication node apparatus to which the UE has been connected before the handover, in handover processing of the UE. Another aspect of the present invention is directed to providing a structure for more flexibly performing handover processing of a communication apparatus via a communication node apparatus.

According to an aspect of the present invention, a communication node apparatus configured to provide a public network communication service includes a transmission unit configured to transmit, in a case of handing over a communication apparatus existing under the communication node apparatus to a different communication node apparatus, association information for associating the communication apparatus with an own node to the communication apparatus or the different communication node apparatus. The association information is information to be used in determining a next handover destination for the communication apparatus handed over to the different communication node apparatus, and is information that makes an effect of increasing a possibility of being selected as the next handover destination.

Further features of the present invention will become apparent from the following description of exemplary embodiments with reference to the attached drawings.

### BRIEF DESCRIPTION OF THE DRAWINGS

FIG. 1 is a diagram illustrating an example of a mobile communication system.

FIG. 2 is a hardware functional block diagram of a communication node.

FIG. 3 is a software functional block diagram of a communication node.

FIG. 4 is a processing sequence diagram of an association handover according to a first exemplary embodiment.

FIG. 5 illustrates a processing flow of the association handover executed by a communication node according to the first exemplary embodiment.

FIG. 6 is a return processing sequence diagram of the association handover according to the first exemplary embodiment.

FIG. 7 illustrates an association handover return processing flow executed by a communication node according to the first exemplary embodiment.

FIG. 8 is a sequence diagram of processing executed by cancellation of the association handover according to the first exemplary embodiment.

FIG. 9 is a processing flow of an association handover executed by a communication node according to a third exemplary embodiment.

FIG. 10 is a sequence diagram of a typical handover to be executed in compliance with a 3rd Generation Partnership Project (3GPP) standard.

### DESCRIPTION OF THE EMBODIMENTS

Hereinafter, each exemplary embodiment will be described in detail with reference to the accompanying drawings.

In the 3rd Generation Partnership Project (3GPP), in response to a demand for improvement in 5G cellular coverage and connectivity, the specification of the following mobile Integrated Access and Backhaul (IAB) is planned to be formulated in the next Release-18. The specification formulation of the mobile IAB implements vehicle-mounted relay in which an IAB node mounted on a vehicle performs base station relay. In the discussion, requirements that cannot be satisfied by the conventional specification, and are specific to a mobility scenario in which an IAB node and a user equipment (UE) moves to each other are considered to be generated. Among these, load distribution of base station relay is included in discussion items. Conventionally, as a mechanism of load distribution and load balance in the base station relay, it has been considered to execute a handover to an upper node (gNB) to which an IAB node connects. In the above-described discussion, it is considered to temporarily execute UE acceptance between IAB nodes at a point where a plurality of base station relays is expected to exist (suspended state near a bus stop or a traffic light).

When a communication node having a function equivalent to a base station like an IAB node hands over a UE that is connected to a corresponding base station, to a different communication node for the purpose of temporary load distribution, it is expected to perform reconnection to an original communication node using connection history information. Nevertheless, in the conventional handover, a structure has not been defined of handing over history information of a connecting base station, to a different base station in association with the UE.

Thus, in a case where the above-described temporary load distribution is tried, a UE cannot correctly recover or reconnect to an IAB node to which the UE had been connected. For this reason, it is considered that an unnecessary handover to a different IAB node occurs or re-selection of an unnecessary cell occurs due to the movement of the UE. In addition, it is also conceivable that a UE connects to a congested IAB node with strong radio field intensity, and an issue arises that it becomes difficult to maintain a stable communication service due to large unnecessary movement-related load.

Hereinafter, a mobile communication system considering the above-described issues will be discussed.

### First Exemplary Embodiment

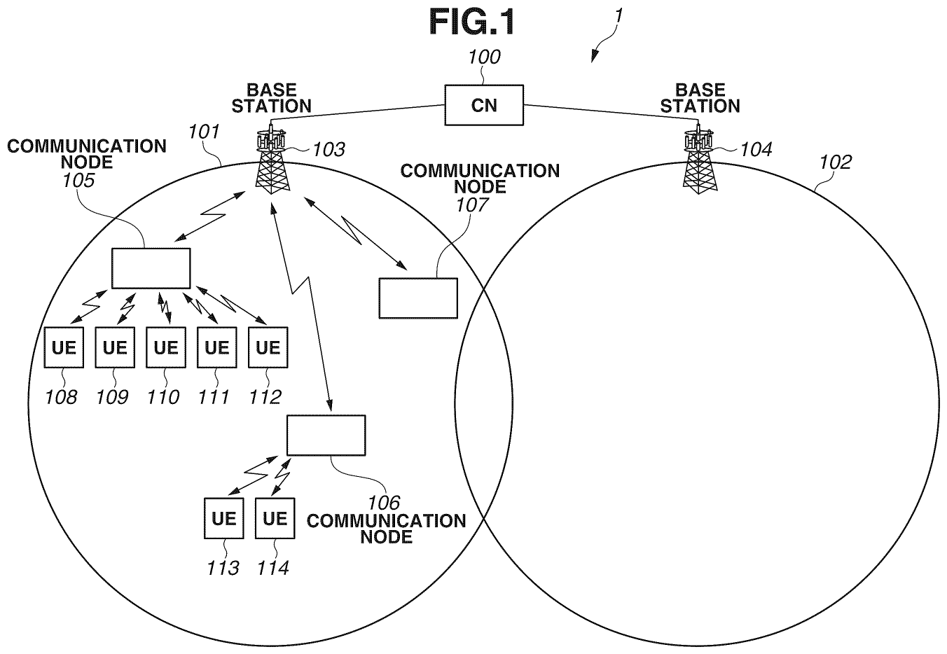

FIG. 1 is a diagram illustrating an example of a mobile communication system 1. In a network that provides a public network communication service to cell coverages 101 and 102, base stations 103 and 104 that provide connection to a core network (CN) 100 exist. Within the cell coverage 101, communication nodes 105 to 107 (an example of a communication node apparatus) are wirelessly connected to the base station 103, thereby forming a network. Here, the CN performs various types of processing such as authentication of UEs 108 to 114 (examples of a communication apparatus) each serving as a terminal.

The base stations 103 and 104 can function as an IAB donor (an example of a donor apparatus), comprehensively control each of the communication nodes 105 to 107 that can function as an IAB node, and form the cell coverages 101 and 102 covered by the respective base stations.

Within the cell coverage 101, a communication packet complying with the format of a backhaul adaptation protocol (BAP) data protocol data unit (PDU) (hereinafter, BAP data packet) is used as a communication packet.

For example, an internet protocol (IP) packet from the CN 100 that is addressed to the UE 108 is converted into a BAP data packet at the base station 103, and transferred to the communication node 105. The transferred BAP data packet is converted again into an IP packet at the communication node 105, and delivered to the UE 108 serving as a destination.

Similarly, an IP packet from the UE 108 is also converted into a BAP data packet at the communication node 105, converted again into an IP packet at the base station 103, and transferred to the CN 100.

The communication nodes 105 to 107 are installed in mobile objects such as electric trains, buses, and taxis, and in a case where the communication nodes 105 to 107 move to the cell coverage 102 over the cell coverage 101, the communication nodes 105 to 107 execute connection change to connection under the base station 104. Transition between base stations is executed via the CN 100.

The UEs 108 to 111 are provided together on a mobile object on which the communication node 105 is installed, and move within the cell coverage 101 together with the communication node 105. The mobile object travels within the cell coverage 101 and the cell coverage 102 in accordance with a planned route.

In the present exemplary embodiment, a case where a communication band congestion occurs between the communication node 105 and the base station 103 is assumed, and association handover processing for load distribution processing to be executed at the communication node 105 will be described.

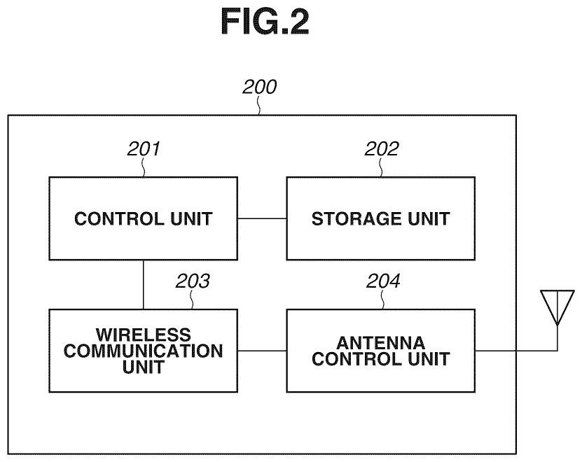

FIG. 2 is a hardware functional block diagram of the communication node 105.

A hardware function 200 of the communication node 105 includes hardware components of a control unit 201, a storage unit 202, a wireless communication unit 203, and an antenna control unit 204.

The control unit 201 controls the entire apparatus by executing control programs stored in the storage unit 202.

The storage unit 202 stores control programs to be executed by the control unit 201, and various types of information such as UE information regarding a UE to be connected, and connection strength with the base station 103. The control unit 201 includes one or more processors such as a central processing unit (CPU) or a micro processing unit (MPU), for example, and controls the entire communication apparatus by executing a control program loaded onto a random access memory (RAM) serving as the storage unit 202. Each piece of processing to be performed by the control unit 201, which will be described below with reference to the following flowchart, can also be implemented with a hardware circuit such as an application specific integrated circuit (ASIC) or a field programmable gate array (FPGA). By making cooperation between a hardware circuit and a processor such as a CPU or an MPU, it is also possible to implement processing to be described below with reference to the following flowchart. The wireless communication unit 203 is a wireless communication unit for performing cellular network communication such as the Long Term Evolution (LTE) or the 5th Generation Mobile Communication System (5G) that complies with the 3GPP standard.

The antenna control unit 204 controls an antenna to be used in wireless communication executed by the wireless communication unit 203.

The hardware of the communication node 105 has been described with reference to FIG. 2, and the communication nodes 106 to 107 also have a similar configuration.

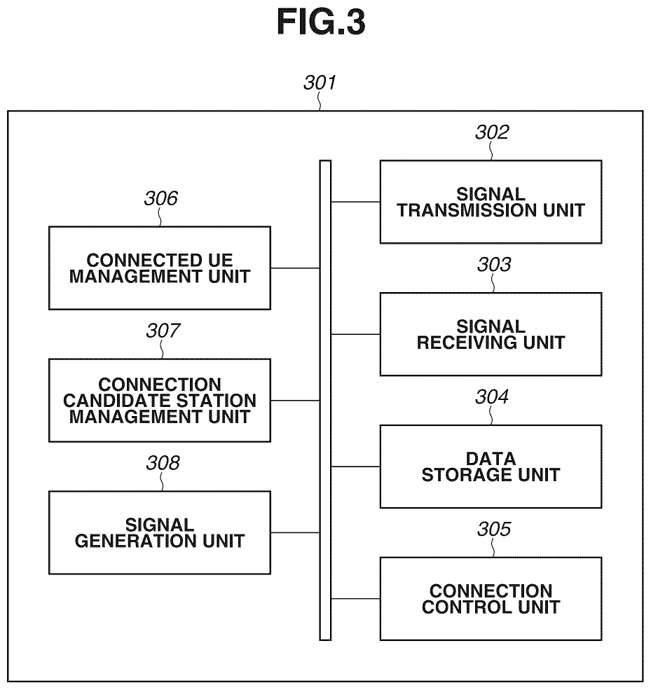

FIG. 3 is a software functional block diagram of the communication nodes 105 to 107. FIG. 3 illustrates a software functional block 301 of any one communication node of the communication nodes 105 to 107.

The software functional block 301 is stored in the storage unit 202 and executed by the control unit 201. The software functional block 301 includes a signal transmission unit 302, a signal receiving unit 303, a data storage unit 304, a connection control unit 305, a connected UE management unit 306, a connection candidate station management unit 307, and a signal generation unit 308.

The signal transmission unit 302 and the signal receiving unit 303 control the wireless communication unit 203 via the control unit 201, and execute cellular network communication such as the Long Term Evolution (LTE) or the 5G that complies with the 3GPP standard, between the base station 103 and the UEs 108 to 114.

The connection control unit 305 also controls the antenna control unit 204 via the control unit 201 during wireless communication.

The data storage unit 304 performs the control or management of the storage unit 202, which is a substantial component, and stores and holds software itself, connection information regarding connection between the base stations 103 and 104, and information regarding the UEs 108 to 114. Information between nodes can be collected using a report signal or a communication packet (hereinafter, BAP data packet) accompanying various control PDUs of the BAP. Information from a UE can be collected from a radio resource control (RRC) status, for example.

The connected UE management unit 306 manages information regarding a UE that is connected to a corresponding base station. The connected UE management unit 306 manages a UE of which handover is to be executed in accordance with a load status of the corresponding base station. The connected UE management unit 306 also manages information regarding a UE of which handover has been executed.

The connection candidate station management unit 307 collects information to be used for determination of a UE handover destination node, from a report signal between communication nodes collected from the data storage unit 304, and manages optimum connection candidate station information in planning a handover of a UE.

The signal generation unit 308 manages and transmits various signals generated by the connection control unit 305 and the connection candidate station management unit 307.

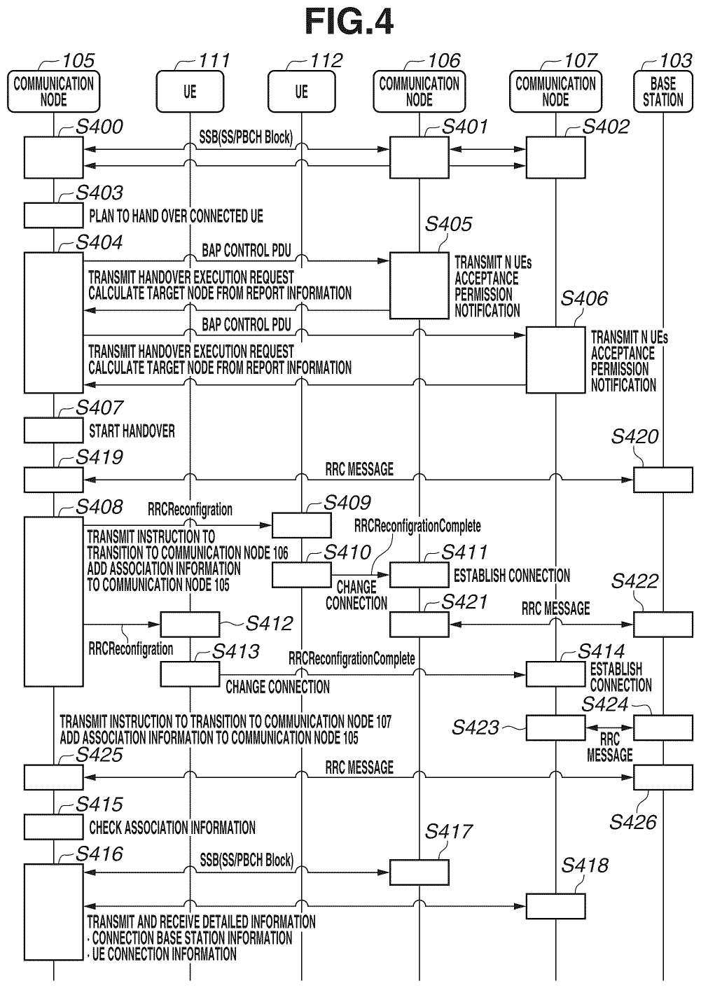

FIG. 4 is a processing sequence diagram of an association handover according to the first exemplary embodiment.

The description will be given of processing to be performed when the communication node 105 executes an association handover of a part of the UEs 108 to 112 that are connected to a corresponding base station, to the communication nodes 106 and 107 for the purpose of load distribution.

Here, the connected UE management unit 306 determines a UE targeted for a handover, in accordance with a use status of a connected UE, and the connection candidate station management unit 307 determines a communication node to which the handover is performed. The signal generation unit 308 generates report information and a BAP data packet.

In step S400, the communication node 105 executes the transmission and reception of a report signal. For the report signal, for example, a synchronization signal/physical broadcast channel (SS/PBCH) Block (SSB) can be used. The same applies to report signals in steps S401 and S402 to be described below. In step S401, the communication node 106 executes transmission and reception of the report signal. In step S402, the communication node 107 executes transmission and reception of the report signal. The report signal can be communicated with the base station 103. In addition, as detailed information to be transmitted and received at the time, the number of UEs that can be accepted, the connection strength with the base station 103, the position of a communication node, a scheduled time of connection with the base station 103, and load of a communication node can be included.

In step S403, the communication node 105 plans a handover of a UE that is connected to the corresponding base station.

In step S404, the communication node 105 transmits a BAP data packet to the communication nodes 106 to 107 as a handover request. At this time, a counterpart communication node that generates and transmits the handover request can determine a priority order based on connection candidate station information preliminarily generated by the connection candidate station management unit 307.

In step S405, the communication node 106 transmits the number of UEs that can be accepted by the corresponding base station, to the communication node 105. In this example, the number of UEs that can be accepted by the corresponding base station is assumed to be “1” or more.

In step S406, the communication node 107 transmits the number of UEs that can be accepted by the corresponding base station, to the communication node 105. In this example, the number of UEs that can be accepted by the corresponding base station is assumed to be “1” or more.

Based on information obtained from the communication nodes 106 and 107 in steps S405 and S406, the communication node 105 determines a UE to be handed over to each communication node.

In step S407, the communication node 105 starts handover processing.

In step S408, the communication node 105 notifies the UE determined in step S404 to be a handover target, of a transition destination communication node using an RRC message, and issues a handover execution instruction. The RRC message can be an RRC Reconfiguration message that is based on the RRC message transmitted from the base station 103 in step S420, for example. At this time, the communication node 105 adds association information to the corresponding base station using the RRC message. The association information can be a communication node ID, a cell ID, a BAP address, or information of that kind. In this case, the cell ID may be different from a cell ID of the base station 103.

In step S409, the UE 112 receives, from the communication node 105, a handover instruction to communication node 106. At this time, the UE 112 receives and holds association information regarding association with the communication node 105.

In step S410, the UE 112 executes connection change to the communication node 106. When the connection change is completed, the UE 112 transmits a completion message of handover processing using an RRC message, to the communication node 106. This completion message is, for example, an RRC Reconfiguration Complete message, and can be transmitted to the base station 103 in step S421 as an RRC message.

In step S411, the communication node 106 confirms the handover completion of the UE 112. At this time, the communication node 106 receives and stores association information of the UE 112 and the communication node 105.

In step S412, the UE 111 receives an instruction to hand over to the communication node 107 that is based on an RRC message from the communication node 105. At this time, the UE 111 receives and holds association information regarding association with the communication node 105.

In step S413, the UE 111 executes connection change to the communication node 107. After the connection change is completed, the UE 111 transmits a completion message of handover processing using an RRC message, to the communication node 107. This completion message is, for example, an RRC Reconfiguration Complete message, and can be transmitted from the communication node 107 to the base station 103 as an RRC message in step S423.

In step S414, the communication node 107 confirms the handover completion of the UE 111. At this time, the communication node 107 receives and stores association information of the UE 111 and the communication node 105.

In step S415, the communication node 105 checks UE information regarding a UE under the association handover that is managed by the connected UE management unit 306.

In step S416, the communication node 105 communicates detailed report information between counterpart communication nodes 106 and 107 in compliance with the association information managed by the connected UE management unit 306. At this time, the detailed report information to be transmitted and received can include the number of UEs that can be accepted, the connection strength with the base station 103, the position of communication node, a scheduled time of connection with the base station 103, and load of a communication node. At this time, the reception of a report signal of a communication node not holding association information is paused.

In step S417, the communication node 106 transmits and receives detailed report information to and from the communication node 105 holding the association information. At this time, the reception of report information of a communication node not holding association information is paused.

In step S418, the communication node 107 transmits and receives detailed report information to and from the communication node 105 holding the association information. At this time, the reception of report information of a communication node not holding association information is paused.

In steps S419 to S426, the communication nodes (105, 106, 107) transmit and receive an RRC message to and from the base station 103. This is a 5G network connection sequence of an IAB node that complies with the 3GPP standard defined by TR38.401.

By such processing illustrated in FIG. 4, association handover processing for load distribution is executed.

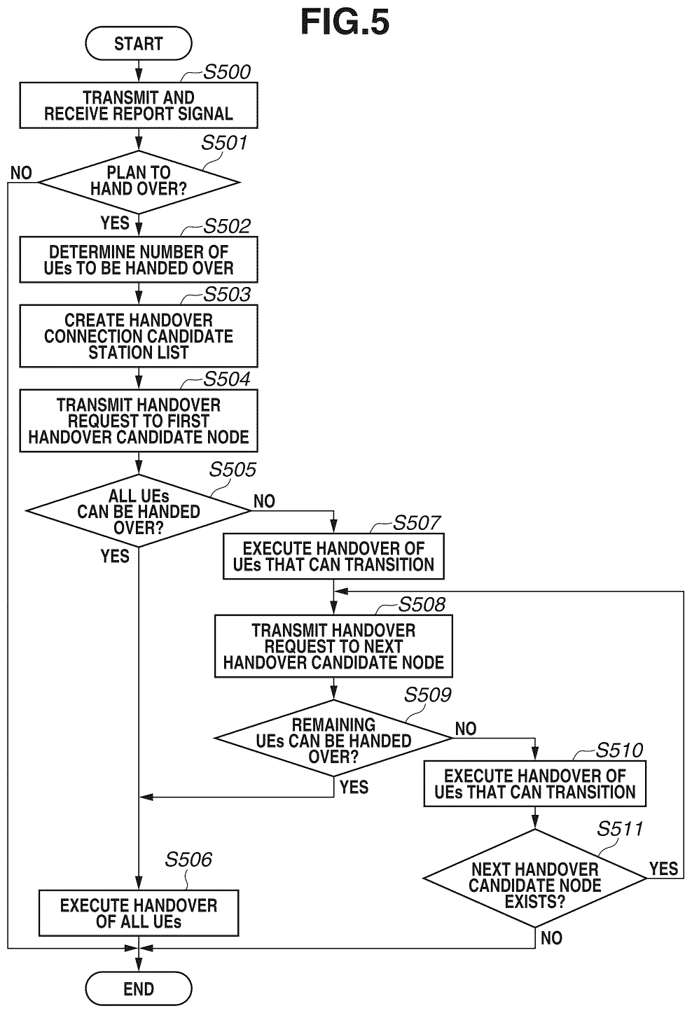

FIG. 5 illustrates a processing flow of the association handover executed by the communication node 105 according to the first exemplary embodiment.

In step S500, the communication node 105 performs transmission and reception of a report signal between the communication nodes 106 and 107. As described above, for example, an SS/PBCH Block (SSB) can be used as the report signal.

In step S501, it is determined whether the communication node 105 plans to hand over. If it is determined that the communication node 105 plans to hand over (YES in step S501), the processing proceeds to step S502. In other cases (NO in step S501), the processing of this cycle ends.

In step S502, the communication node 105 determines the number of UEs of which the handover is to be executed by the connected UE management unit 306. At this time, the communication node 105 determines the number of UEs to be handed over, and a target UE based on a load status and a usage status of a connected UE of the corresponding base station.

In step S503, the communication node 105 determines an order of a transition communication node of which the handover is to be executed, based on information in the connection candidate station management unit 307 (e.g., a handover connection candidate station list). At this time, a priority order of a transition node can be determined from information collected as detailed report information (e.g., the number of UEs that can be accepted, the connection strength with the base station 103, the position of a communication node, a scheduled time of connection with the base station 103, and load of a communication node).

In step S504, the communication node 105 transmits a handover request to a first priority order communication node of a transition target node that has been determined by the connection candidate station management unit 307.

In step S505, the communication node 105 determines whether all UEs planned to be handed over to a counterpart communication node can be handed over. In a case where all UEs can be handed over (YES in step S505), the processing proceeds to step S506. In a case where all UEs cannot be handed over (NO in step S505), the processing proceeds to step S507.

In step S506, the communication node 105 executes the handover of all UEs planned to be handed over.

In step S507, the communication node 105 executes the handover of UEs by the number of UEs that can transition, which has been replied from a counterpart communication node.

In step S508, the communication node 105 transmits a handover request to a next-order communication node of a connection candidate station that has been determined in step S503.

In step S509, the communication node 105 determines whether the remaining number of UEs can be handed over. In a case where the remaining number of UEs can be handed over (YES in step S509), the processing proceeds to step S506. In a case where the remaining number of UEs cannot be handed over (NO in step S509), the processing proceeds to step S510.

In step S510, the communication node 105 executes the handover of UEs by the number of UEs that can transition, which has been replied from a counterpart communication node.

In step S511, the communication node 105 determines whether the next transition candidate node exists. In a case where the next transition candidate node exists (YES in step S511), the processing returns to step S508. In contrast, the next transition candidate node does not exist (NO in step S511), the processing of this cycle ends.

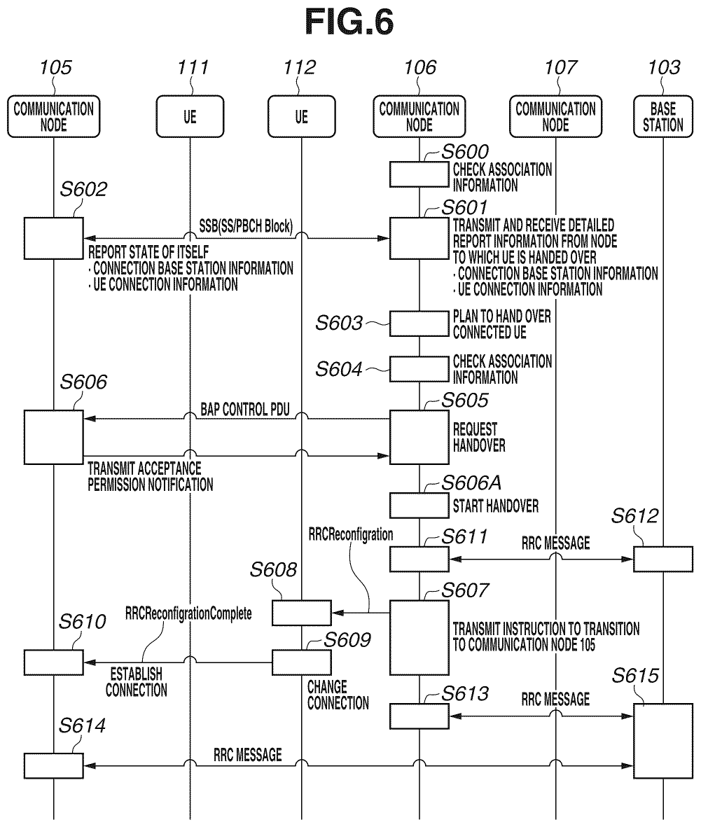

FIG. 6 illustrates a return processing sequence of the association handover according to the first exemplary embodiment.

Here, as an example, processing of returning the UE 112 to the communication node 105 in a state in which the association handover of the UE 112 from the communication node 105 to the communication node 106 is executed will be described. The processing of returning the UE 111 to the communication node 105 in a state in which the association handover of the UE 111 from the communication node 105 to the communication node 107 is executed can be similar.

In step S600, the communication node 106 checks whether that association information regarding association with the communication node 105 is held, based on information regarding the UE 112 that is connected to the corresponding base station. The association information for a UE is managed by the connected UE management unit 306.

In step S601, the communication node 106 transmits and receives detailed report information to and from the communication node 105.

In step S603, the communication node 106 plans to hand over a UE, based on a request from the communication node 105, or determination by the corresponding base station.

In step S604, the communication node 106 checks association information of a UE.

In step S605, the communication node 106 transmits a handover request. At this time, the communication node 106 determines a communication node to which a handover request is transmitted, in accordance with the priority order of connection candidate stations managed by the connection candidate station management unit 307.

In step S606, the communication node 105 transmits an acceptance permission notification in response to the handover request from the communication node 106.

In step S606A, the communication node 106 starts the handover.

In step S607, the communication node 106 transmits a connection change instruction (RRC Reconfiguration message) for issuing an instruction to transition to the communication node 105, to the UE 112 based on an RRC message transmitted from the base station 103 in step S612.

In step S608, the UE 112 receives an instruction of connection change to the communication node 105.

In step S609, the UE 112 executes connection change to the communication node 105 in response to the connection change instruction. When the connection change is completed, the UE 112 transmits a completion message of handover processing that uses an RRC message, to the communication node 105. The completion message is, for example, an RRC Reconfiguration Complete message, and can be transmitted to the base station 103 in step S614 as an RRC message.

In step S610, the communication node 105 establishes connection of the UE 112. In this case, the communication node 105 discards the association information, and can notify the UE 112 and the communication node 106 of the discard of the association information.

In steps S611 to S615, the communication nodes 105 and 106 transmit and receive an RRC message to and from the base station 103. This is a 5G network connection sequence of an IAB node that complies with the 3GPP standard defined by the TR38.401.

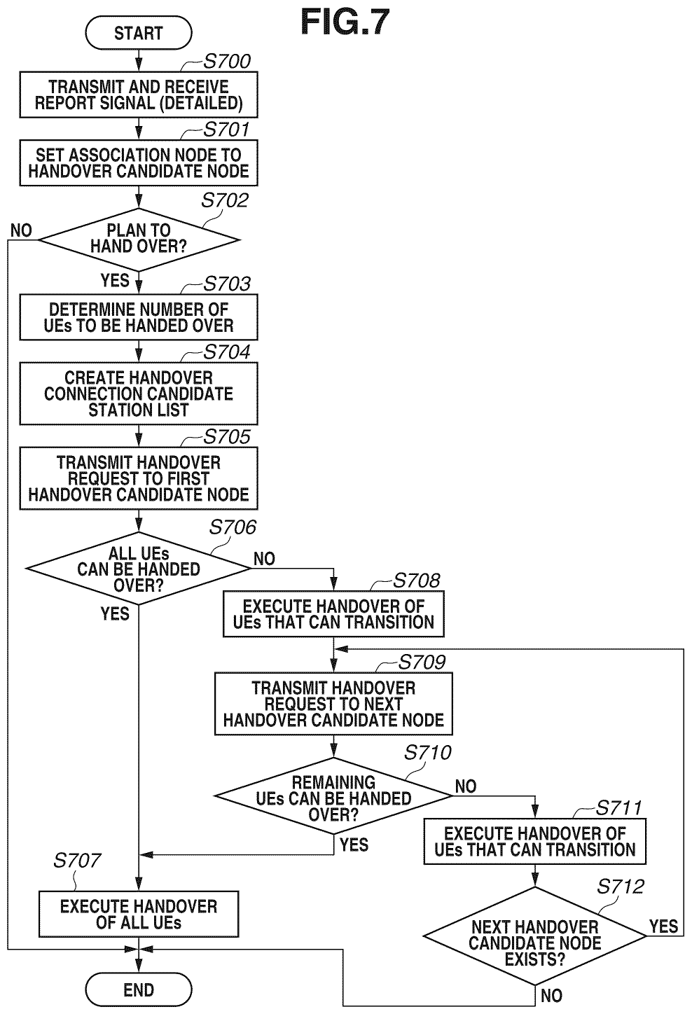

FIG. 7 illustrates a return processing flow of the association handover to be executed by the communication node 106 according to the first exemplary embodiment.

In step S700, the communication node 106 transmits and receives a detailed report signal to and from the communication node 105. As described above, for example, an SS/PBCH Block (SSB) can be used as the report signal.

In step S701, the communication node 106 sets an association node as a first connection candidate station based on association information of a UE. Second and subsequent connection candidate stations can be determined in a similar manner to step S503 illustrated in FIG. 5. In this case, in a case where an association node is raised to the first place, an order determined in a similar manner to step S503 illustrated in FIG. 5 can be accordingly corrected. In the present exemplary embodiment, a base station that has not acquired a signal corresponding to an association node, or a base station with a weak signal that is unsuitable as a handover destination is not treated as a connection candidate station. In other words, in a case where an association node is not included in connection candidate stations, the communication node 106 is only required to determine the order of connection candidate stations including the first connection candidate station, in a similar manner to step S503 illustrated in FIG. 5.

Other processing sequences are similar to those illustrated in FIG. 5, and thus the detailed description will be omitted.

In FIG. 7, in a case where the number of UEs to be handed over is two or more, and in a case where an association node that is based on association information of each UE varies, the handover to an association node that is based on corresponding association information can be preferentially executed separately.

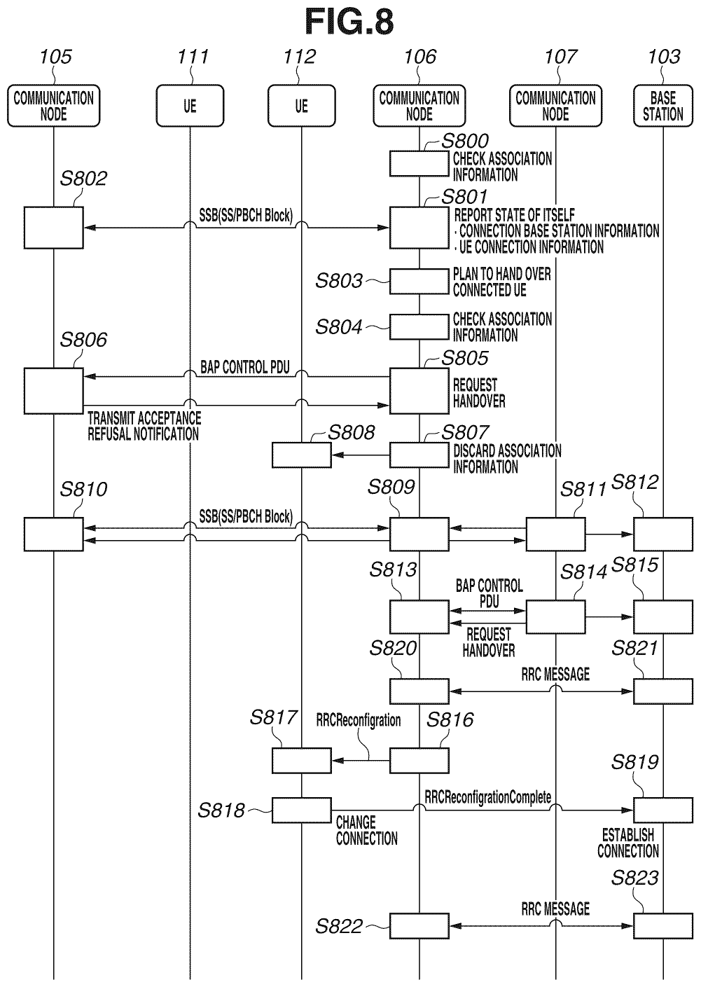

FIG. 8 illustrates a processing sequence by cancellation of the association handover according to the first exemplary embodiment.

The processing in steps S800 to S805 is similar to the processing in steps S600 to S605 that has been described with reference to FIG. 6, and thus the detailed description will be omitted.

In step S806, the communication node 105 rejects acceptance of a UE to the corresponding base station.

In step S807, the communication node 106 discards association information regarding association of the UE 112 with the communication node 105, managed by the connected UE management unit 306, and notifies the UE 112 of the discard of association information.

In step S808, the UE 112 discards association information regarding association with the communication node 105.

In step S809, the communication node 106 restarts the transmission and reception of a report signal to and from a communication node and the base station 103 that have been stopped.

In steps S810, S811, and S812, the communication node 105, the communication node 107, and the base station 103 also restart the transmission and reception of a report signal to and from the communication node 106.

In step S813, the communication node 106 transmits a handover request to a connection candidate station in the connection candidate station management unit 307.

In step S814, the communication node 107 transmits a response to the handover request.

In step S815, the base station 103 transmits a response to the handover request.

In step S816, the communication node 106 transmits an instruction of handover for the base station 103 (e.g., RRC Reconfiguration message that is based on an RRC message transmitted from the base station 103 in step S821), to the UE 112.

In step S817, the UE 112 receives the handover instruction.

In step S818, the UE 112 executes connection change to the base station 103 in response to the handover instruction. When the connection change is completed, the UE 112 transmits a completion message (RRC Reconfiguration Complete message) of handover processing that uses an RRC message, to the base station 103.

In step S819, the base station 103 establishes connection with the UE 112.

In steps S820 to S823, the communication nodes 105 to 107 execute communication of an RRC message with the base station 103 (FIG. 8 illustrates only communication between the communication node 106 and the base station 103). This is a 5G network connection sequence of an IAB node that complies with the 3GPP standard defined by the TR38.401.

In contrast, in a comparative example in which association information is not used unlike the present exemplary embodiment, a possibility that, after the UE 112 existing under the communication node 105 is handed over to the communication node 106, the communication node 105 is not preferentially selected as the next handover destination becomes higher. In this case, for example, if the communication node 107 is selected as the next handover destination, the UE 112 is handed over to the communication node 107. In this case, the following inconvenience can be generated. If the UE 112 moves together with the communication node 105 thereafter, a possibility that a handover is required again becomes higher by a distance from the communication node 107 increasing.

In this case, the UE 112 can then be eventually handed over to the communication node 105. Such repetition of the handover is inefficient, and leads to an increase in processing load. According to the present exemplary embodiment, such inconvenience can be reduced by determining the next handover destination using association information.

In the first exemplary embodiment, the communication node 106 is installed on a mobile object similarly to the communication node 105, but can be installed on a stationary object. The same applies to other exemplary embodiments (e.g., second exemplary embodiment, etc.) to be described below.

### Second Exemplary Embodiment

In a second exemplary embodiment, the management of a UE in a communication node performing an association handover of a UE will be described.

When a communication node executes an association handover of a UE, the connected UE management unit 306 of the corresponding base station manages a target UE as a terminal to be connected to the corresponding base station.

In a case where the number of connected UEs is limited, the number of connected UEs including the above-described UE is counted. In a case where communication state of the corresponding base station improves, the return of the target UE to the corresponding base station is preferentially executed.

### Third Exemplary Embodiment

In a third exemplary embodiment, an association handover is assumed to be executed only between communication nodes not via a UE.

The return to a communication node that is on the initiative of a UE cannot be executed, but it becomes possible to simplify handover processing.

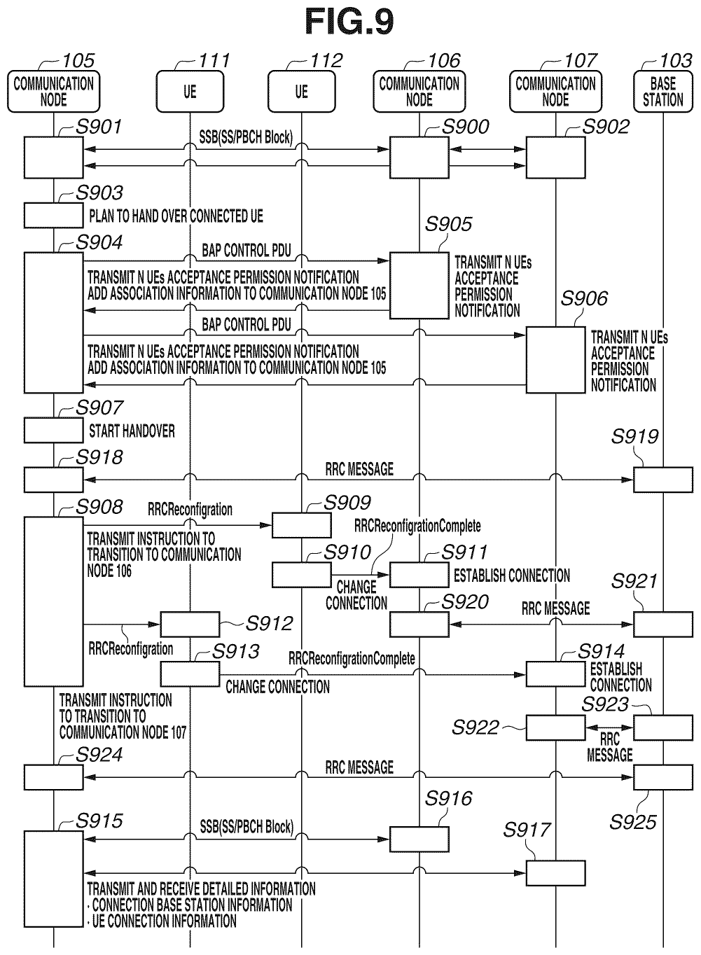

FIG. 9 is a processing sequence diagram of an association handover between communication nodes according to the third exemplary embodiment.

In steps S900, S901, and S902, the communication nodes 105, 106, and 107 transmit and receive a report signal. As described above, for example, an SS/PBCH Block (SSB) can also be used as the report signal.

In step S903, the communication node 105 plans to hand over a UE.

In step S904, the communication node 105 transmits a handover request to the communication nodes 106 and 107. At this time, the communication node 105 adds association information regarding association with the corresponding base station, to the handover request, and transmits the handover request.

In step S905, the communication node 106 permits UE acceptance, and receives association information of the communication node 105.

In step S906, the communication node 107 permits UE acceptance, and receives association information of the communication node 105.

In step S907, the communication node 105 executes the handover.

In step S908, the communication node 105 transmits an instruction to hand over to the communication node 106, to the UE 112, and transmits an instruction to hand over to the communication node 107, to the UE 111.

In step S909, the UE 112 receives the handover instruction from the communication node 105.

In step S910, the UE 112 executes connection change to the communication node 106.

In step S911, the communication node 106 establishes connection of the UE 112.

In step S912, the UE 111 receives the handover instruction from the communication node 105.

In step S913, the UE 111 executes connection change to the communication node 107.

In step S914, the communication node 107 establishes connection of the UE 111.

In step S915, the communication node 105 communicates detailed report information between counterpart communication nodes 106 and 107 in compliance with association information managed by the connected UE management unit 306. At this time, detailed information to be transmitted and received can include the number of UEs that can be accepted, the connection strength with the base station 103, the position of a communication node, a scheduled time of connection with the base station 103, and load of a communication node.

In step S916, the communication node 106 transmits and receives detailed report information to and from the communication node 105 holding association information. At this time, the reception of report information of a communication node not holding association information can be paused.

In step S917, the communication node 107 transmits and receives detailed report information to and from the communication node 105 holding association information. At this time, the reception of report information of a communication node not holding association information can be paused.

In steps S918 to S925, the communication nodes 105, 106, and 107 transmit and receive an RRC message to and from the base station 103. This is a 5G network connection sequence of an IAB node that complies with the 3GPP standard defined by the TR38.401.

As described above, it is possible to execute an association handover of a communication node, and it accordingly becomes possible to realize load distribution of communication nodes.

### Other Exemplary Embodiments

As described in the above-described exemplary embodiments, when a handover is executed between a communication node and a UE, association information regarding association with the communication node is added using an RRC message. As a parameter to be used at the time, an undefined parameter such as nonCriticalExtension defined by nas-Container or Release-17 can be used. In communication between communication nodes during a handover, a BAP control PDU can be used. Furthermore, a reserved field in the BAP control PDU can also be used. In addition, an SS/PBCH Block (SSB) can also be used as a detailed report signal described in step S416 described above.

In each of the above-described exemplary embodiments, association information regarding association with one UE is stored in the one UE and a communication node related to the handover of the one UE (i.e., handover source and handover destination communication nodes). Nevertheless, the association information regarding association with one UE can be stored in the base station 103 of the communication node. In this case, a handover destination can be determined by the base station 103 in compliance with the 3GPP standard defined by the TR38.401 and the like. More specifically, for example, in the case of the example illustrated in FIG. 4, the base station 103 can manage the following various types of information. The various types of information can include the numbers of connected UEs of the communication node 105, the communication node 106, and the communication node 107, the number of UEs that can be accepted, the connection strength with the base station 103 (communication quality), the positions of the communication nodes 105, 106, and 107, and a scheduled time of connection with the base station 103. The various types of information can also include information regarding load of the communication nodes 105, 106, and 107. These piece of information can be reported from the communication nodes 105, 106, and 107 to the base station 103 by using an F1-Application Protocol (AP).

Based on the information, the base station 103 can determine to which of the communication nodes 106 and 107 the UE 111 is to be handed over. At this time, in a case where the base station 103 determines to hand over the UE 111 to the cell of the communication node 106, for example, the base station 103 generates an RRC message for issuing an instruction to hand over the UE 111 to the cell of the communication node 106. The base station 103 then transmits the generated RRC message via the communication node 105.

Specifically, the base station 103 includes the generated RRC message into a UE CONTEXT MODIFICATION REQUEST of the F1-AP and transmits the UE CONTEXT MODIFICATION REQUEST to the communication node 105. The communication node 105 takes out an RRC Reconfiguration message from the received UE CONTEXT MODIFICATION REQUEST, and transmits the RRC Reconfiguration message to the UE 111. The base station 103 stores association information (e.g., cell ID, etc.) indicating that the UE 111 has been handed over from the cell of the communication node 105 to the cell of the communication node 106.

The UE 111 that has received the RRC Reconfiguration message performs processing of handing over from the communication node 105 to the communication node 106.

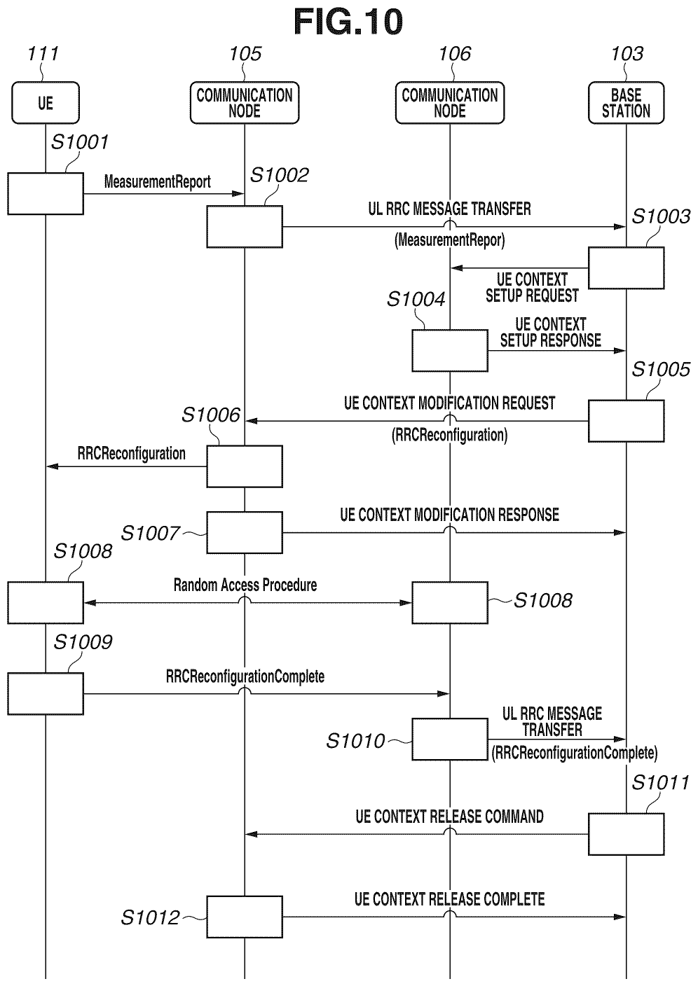

In the above-described exemplary embodiment, handover processing has been described with communication of messages regarding a handover, which is partially simplified because of space limitations. The measurement of radio field intensity for the handover and a procedure of the handover that have been described in the above-described exemplary embodiments specifically correspond to each piece of processing illustrated in FIG. 10. Hereinafter, each piece of processing regarding the handover that has been described in the above-described exemplary embodiments in a simplified manner will be described in more detail with reference to FIG. 10. Because of space limitations and in order to avoid complication of description, the description will be given with reference to FIG. 10 in which communication of information that is executed between apparatuses for each handover is extracted.

FIG. 10 is a sequence diagram illustrating communication for the handover according to each exemplary embodiment. In each exemplary embodiment, 3GPP standard handover processing defined by the TR38.401 is performed. Specific description will be given below. In step S1001, the UE 111 transmits a Measurement Report message to the communication node 105. In step S1002, the communication node 105 transfers the Measurement Report message to the base station 103 by transmitting UL RRC MESSAGE TRANSFER to the base station 103. At this time, the base station 103 and the communication node 105 can perform communication of a UE CONTEXT MODIFICATION REQUEST message and a UE CONTEXT MODIFICATION RESPONSE message. In step S1003, the base station 103 transmits a UE CONTEXT SETUP REQUEST message to the communication node 106, which is a handover destination. The UE CONTEXT SETUP REQUEST message can include various types of preparation information for performing a handover. In step S1004, the communication node 106 makes a response to the base station 103 using a UE CONTEXT SETUP RESPONSE message. In step S1005, the base station 103 transmits a UE CONTEXT MODIFICATION REQUEST message to the communication node 105. The UE CONTEXT MODIFICATION REQUEST message can include an RRC Reconfiguration message and a data transmission stop instruction for the UE 111. In step S1006, the communication node 105 transfers the received RRC Reconfiguration message to the UE 111. In step S1007, the communication node 105 makes a response to the base station 103 using a UE CONTEXT MODIFICATION RESPONSE message. Subsequently, in step S1008, a random access procedure is executed by the communication node 106, and the communication node 106 transmits a Downlink Data Delivery Status frame and the like. In step S1009, the UE 111 makes a response to the communication node 106 using an RRC Reconfiguration Complete message. In addition, in step S1010, the communication node 106 transfers an RRC Reconfiguration Complete message to the base station 103 by transmitting UL RRC MESSAGE TRANSFER to the base station 103.

In step S1011, the base station 103 transmits a UE CONTEXT RELEASE COMMAND message to the communication node 105. In step S1012, the communication node 106 makes a response to the base station 103 using a UE CONTEXT RELEASE COMPLETE message. In this case, the base station 103 can recognize that a handover source is the communication node 105, and thus the base station 103 can generate and hold association information regarding association with the communication node 105, by itself.

Heretofore, each exemplary embodiment has been described in detail, but the present invention is not limited to a specific exemplary embodiment, and various modifications and changes can be made within the scope set forth in the appended claims. All or a plurality of components in the above-described exemplary embodiments can also be combined.

For example, in the above-described exemplary embodiment, a wireless access method is New Radio (NR), which is a 5G wireless access method, but the wireless access method is not limited to this. For example, a different access method, such as Long Term Evolution (LTE), the 6th Generation Mobile Communication System (6G) or newer systems, and Wireless Fidelity (Wi-Fi), may also be applied at least partially.

In addition, association information can also be added using an undefined parameter such as nonCriticalExtension defined by nas-Container or Release-17, as a parameter, for example.

The present invention is not limited to the above-described exemplary embodiments, and various changes and modifications can be made without departing from the spirit and scope of the present invention. Accordingly, to publicize the scope of the present invention, the following claims are appended.

According to an aspect of the present invention, it becomes possible to appropriately issue a notification including information for preferentially handing over a UE again to an original communication node apparatus to which the UE connects before a handover, in handover processing of the UE. According to another aspect of the present invention, it becomes possible to provide a structure for more flexibly performing handover processing of a communication apparatus via a communication node apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A communication node apparatus configured to provide a public network communication service comprising:
a transmission unit configured to transmit, in a case of handing over a communication apparatus existing under the communication node apparatus to a different communication node apparatus, association information for associating the communication apparatus with an own node, to the communication apparatus or the different communication node apparatus,
wherein the association information is information to be used in determining a next handover destination for the communication apparatus handed over to the different communication node apparatus, and is information that makes an effect of increasing a possibility of being selected as the next handover destination.

2. The communication node apparatus according to claim 1, further comprising a storage unit configured to hold the association information in a case where the communication apparatus related to the association information is handed over to the different communication node apparatus.

3. The communication node apparatus according to claim 2, further comprising a processing unit configured to make a response to a request for a handover destination from the different communication node apparatus in such a manner that the communication apparatus related to the association information is preferentially handed over to the own node, in a case where the association information is held in the storage unit.

4. The communication node apparatus according to claim 3, wherein, in a case where the processing unit rejects the request from the different communication node apparatus that is the request for handing over the communication apparatus related to the association information to the own node, the processing unit discards the association information in the storage unit.

5. The communication node apparatus according to claim 2, wherein, in a case where the association information is held in the storage unit, the transmission unit further reports a state of connection with a donor apparatus to which the own node connects, to the different communication node apparatus.

6. The communication node apparatus according to claim 2, wherein, in a case where the association information is held in the storage unit, the transmission unit further reports detailed information of the own node to the different communication node apparatus.

7. A communication node apparatus configured to provide a public network communication service, the communication node apparatus comprising:
a receiving unit configured to receive, in a case where a communication apparatus existing under a different communication node apparatus is handed over from the different communication node apparatus to an own node, association information for associating the communication apparatus with the different communication node apparatus; and
a processing unit configured to perform processing of determining a next handover destination for the communication apparatus related to the association information, based at least on the association information,
wherein the association information is information functioning as a parameter that increases a possibility of being selected as the next handover destination in the determining processing.

8. The communication node apparatus according to claim 7, wherein the receiving unit receives the association information via the communication apparatus.

9. The communication node apparatus according to claim 7, further comprising a storage unit configured to hold the association information in a case where the communication apparatus related to the association information is handed over to the own node.

10. The communication node apparatus according to claim 9, wherein, in a case where the association information is held in the storage unit, the receiving unit further acquires a state of connection with a donor apparatus to which the different communication node apparatus connects, from the different communication node apparatus.

11. The communication node apparatus according to claim 9, wherein, in a case where the association information is held in the storage unit, the receiving unit further acquires detailed information of the different communication node apparatus from the different communication node apparatus.

12. The communication node apparatus according to claim 9, wherein, in a case where the association information is held in the storage unit, the processing unit preferentially hands over the communication apparatus related to the association information, to the different communication node apparatus related to the association information.

13. The communication node apparatus according to claim 9, wherein, in a case where the association information is held in the storage unit, when handing over the communication apparatus related to the association information to a different node, the processing unit initially transmits a request for a handover destination to the different communication node apparatus related to the association information.

14. The communication node apparatus according to claim 13, wherein, in a case where the request is rejected by the different communication node apparatus related to the association information, the processing unit transmits a request for a handover destination to the different node and discards the association information in the storage unit.

15. A communication apparatus configured to execute, based on association information that is association information generated in accordance with a handover of the communication apparatus from one communication node apparatus to a different one communication node apparatus and association information for associating the communication apparatus with the one communication node apparatus, processing for a handover from the different one communication node apparatus to the one communication node apparatus or to further different new one communication node apparatus.

16. The communication apparatus according to claim 15, comprising:
a receiving unit configured to receive, in a case where the handover of the communication apparatus is executed from the one communication node apparatus to the different one communication node apparatus, the association information from the one communication node apparatus;
a storage unit configured to store the association information received by the receiving unit; and
a transmission unit configured to transmit, in a case where the handover of the communication apparatus to the different one communication node apparatus is completed, the association information to the different one communication node apparatus.

17. The communication apparatus according to claim 16, further comprising a processing apparatus configured to discard the association information in the storage unit, in a case where a request for the handover from the different one communication node apparatus to the one communication node apparatus related to the association information is rejected by the one communication node apparatus.

18. A communication system including a plurality of communication node apparatuses,
wherein the plurality of communication node apparatuses includes
a generating unit configured to generate, in a case of handing over one communication apparatus from one communication node apparatus to a different one communication node apparatus, association information for associating the one communication apparatus with the one communication node apparatus, and
a unit configured to determine, in a case of newly handing over the one communication apparatus handed over to the different one communication node apparatus, a communication node apparatus as a handover destination, based on the association information, and
wherein the association information is information functioning as a parameter that increases a possibility of being selected as the handover destination.
